(19) United States
(12) Patent Application Publication
(10) Pub. No.: US 2015/0032656 A1
(43) Pub. Date: Jan. 29, 2015

(54) System and Methods for Determining Supply Chain Freight Costs

(71) Applicants: Christopher Ricciardi, Chicago, IL (US); Robert NATHAN, Chicago, IL (US)

(72) Inventors: Christopher Ricciardi, Chicago, IL (US); Robert NATHAN, Chicago, IL (US)

(21) Appl. No.: 14/339,195

(22) Filed: Jul. 23, 2014

Related U.S. Application Data
(60) Provisional application No. 61/857,561, filed on Jul. 23, 2013.

(51) Int. Cl. G06Q 10/08

(52) U.S. Cl. CPC G06Q 10/08345; G06Q 10/0838
USPC 705/335

(57) ABSTRACT

A central logistics system may be provided and configured to host a website accessible to goods providers and freight providers. Through the website, the central logistics system may receive data (e.g., bids, quotes, and other messages and data) from goods and freight providers, and send data (e.g., bids, quotes, and other messages and data) to goods and freight providers. This data exchange, in part, enables the collaborative trade of bids and quotes between multiple goods providers and multiple freight providers in a centralized fashion.

### CROSS-REFERENCE TO RELATED APPLICATION

This application claims the benefit of U.S. provisional application No. 61/857,561, filed Jul. 23, 2013.

### BACKGROUND

a. Technical Field

The instant disclosure relates to the management of supply chain logistics, including freight costs.

b. Background Art

Numerous businesses and industries depend on the transport of goods between cities, states, regions, and countries. A plethora of options exist for transporting any given set of goods—air, ground, and water modalities may all be available and, within each modality, a large number of vehicle types, routes, and providers may be available. Accordingly, a wide range of potential costs and speeds are possible for nearly any shipment.

For businesses that require frequent shipment of goods to maintain a supply chain, minimizing freight costs is key, as is predictability of freight costs. As a result, the field of freight logistics plays an ever-increasing role in business. Third-party consulting, brokerage, and other services all may be available to a business to assist in determining freight costs, including minimizing and predicting freight costs. However, known third-party services may be insufficient to meet the full set of needs of a business in determining its supply chain freight costs.

### BRIEF SUMMARY

Freight logistics systems known in the art can be improved upon by centralizing features (e.g., through a single portal or website) in a collaborative environment in which goods providers and freight providers can exchange quotes and bids based on robust, detailed information about past quotes and bids. Thus, a system that improves on known systems may include a central logistics system in communication with a plurality of goods providers and a plurality of freight providers and a repository of historical freight data.

The central logistics system may be configured to host a website accessible to the goods providers and the freight providers. Through the website, the central logistics system may be further configured to receive data (e.g., bids, quotes, and other messages and data) from users, and send data to users (e.g., bids, quotes, and other messages and data). This data exchange, in part, enables the collaborative trade of bids and quotes between multiple goods providers and multiple freight providers in a centralized fashion.

The website provided by the central logistics system may include a number of useful features to enhance the quote and bid determination process. For example, the central logistics system may compute and provide a predicted freight cost according to a multiple regression analysis of past rates for similar shipments. Further, the central logistics system may provide an indication of the stability of rates for a given freight route. The central logistics system may also find and provide rates for common carriers not bidding through the system itself for comparison to bid rates. For example, the central logistics system may find or otherwise receive rate data from external market rate sources (e.g., aggregated data regarding current and historical prevailing rates), from carriers themselves (e.g., from a carrier's website), and/or from one or more other transportation management software services. Thus, the central logistics system may provide and enable a centralized system through which goods providers and freight providers can exchange freight cost bids, quotes, and negotiations, and award freight assignments, all with the use of past data to aid in determination of appropriate costs, bids, and quotes.

### BRIEF DESCRIPTION OF THE DRAWINGS

FIG. 1 is a block diagram view of a system for determining supply chain freight costs.

FIG. 2 depicts an embodiment of a login page for a supply chain logistics website.

FIG. 3 depicts an embodiment of a landing page for a supply chain logistics website for a goods provider.

FIG. 4 depicts an embodiment of a landing page for a supply chain logistics website for a freight provider.

FIG. 5 depicts an example of a shipping route determination feature for a supply chain logistics website.

FIG. 6 depicts an example of a rate calculation feature for a supply chain logistics website.

FIG. 7 depicts an example of a group rate request feature for a supply chain logistics website.

FIG. 8 depicts an example of an individual rate request feature for a supply chain logistics website.

FIG. 9 depicts an example of a customer quote feature for a supply chain logistics website.

FIG. 10 depicts an exemplary listing of available tractors that may be provided through a supply chain logistics website.

FIG. 11 depicts an exemplary interactive plot of historical freight costs that may be provided through a supply chain logistics website.

FIG. 12 depicts an exemplary chart of historical freight costs that may be provided through a supply chain logistics website.

FIG. 13 depicts an exemplary external carrier freight cost search that may be provided through a supply chain logistics website.

FIG. 14 depicts an exemplary rate detail display that may be provided through a supply chain logistics website.

FIGS. 15 and 16 depict an exemplary capacity request function that may be provided through a supply chain logistics website.

FIG. 17 depicts an exemplary intermodal cost saver function that may be provided through a supply chain logistics website.

FIG. 18 depicts an exemplary weather notification feature that may be provided through a supply chain logistics website.

FIGS. 19-22 depict exemplary rate request listing pages that may be provided through a supply chain logistics website.

FIG. 23 depicts an exemplary quote tracking feature that may be provided through a supply chain logistics website.

FIG. 24 depicts an exemplary company information feature that may be provided through a supply chain logistics website.

FIGS. 25-31 depict an exemplary data exchange feature, for importing and exporting data, that may be provided through a supply chain logistics website.

FIG. 32 depicts an exemplary menu for a rating tool.

FIG. 33 depicts an exemplary “Help” page.

FIGS. 34-35 depict an exemplary contracted freight rate tacking feature that may be provided through a supply chain logistics website.

FIGS. 36-37 depict exemplary tracked usage of multiple users of a supply chain logistics website.

FIGS. 38-40 depict an exemplary user profile feature of a supply chain logistics website.

FIG. 41 depicts an exemplary company profile feature of a supply chain logistics website that may allow external data sources to be integrated with the supply chain logistics website.

### DETAILED DESCRIPTION

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment,” or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

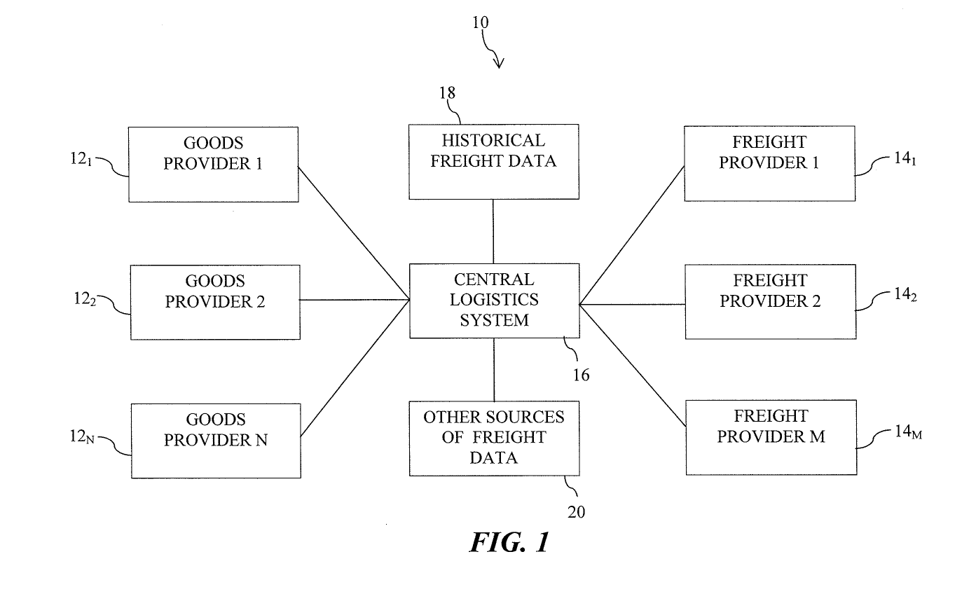

Referring now to the figures, in which like numerals indicate the same or similar elements in the various views, FIG. 1 is a block diagram view of a system 10 for determining supply chain freight costs. The system 10 may include a number N of goods providers 12₁, 12₂, . . . , 12_{N} a number M of freight providers 14₁, 14₂, . . . 14_{M}, a central logistics system 16, a repository of historical freight data 18, and one or more other sources of freight data 20.

The central logistics system 16 may serve as an intermediary between goods providers 12 and freight providers 14. In that role, the central logistics system 16 may provide a collaborative environment for goods providers 12 and freight providers 14 to determine freight costs and to share bid requests, bids, and needs for shipments. The central logistics system 16 may provide, for example, a website with which goods providers 12 and freight providers 14 may interact. Through the website, goods providers 12 may connect with freight providers 14 to determine freight rates and ship goods.

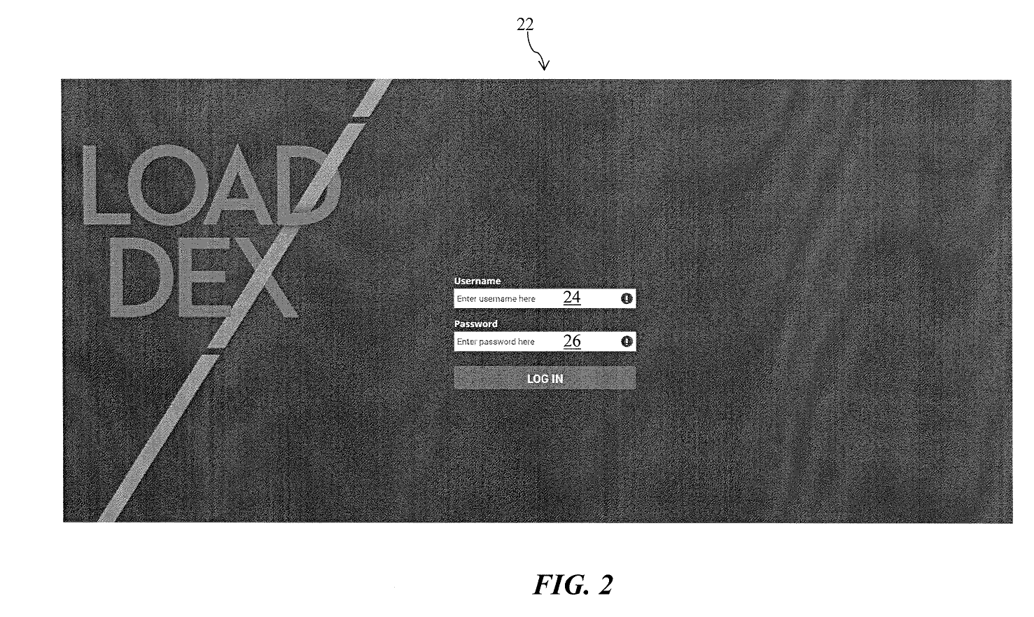

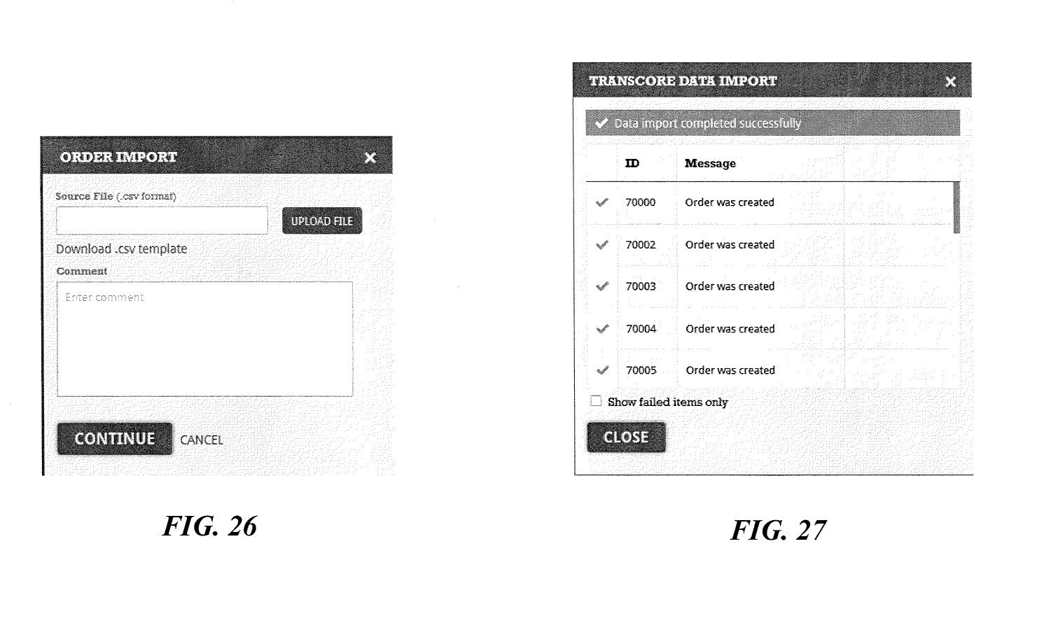

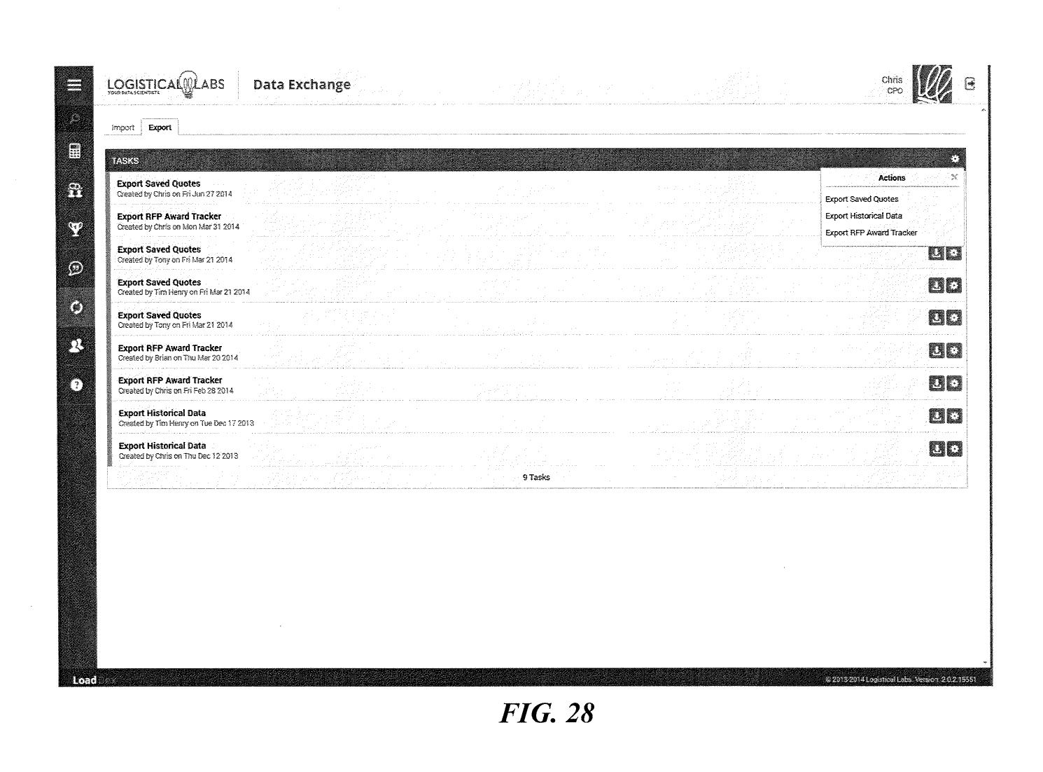

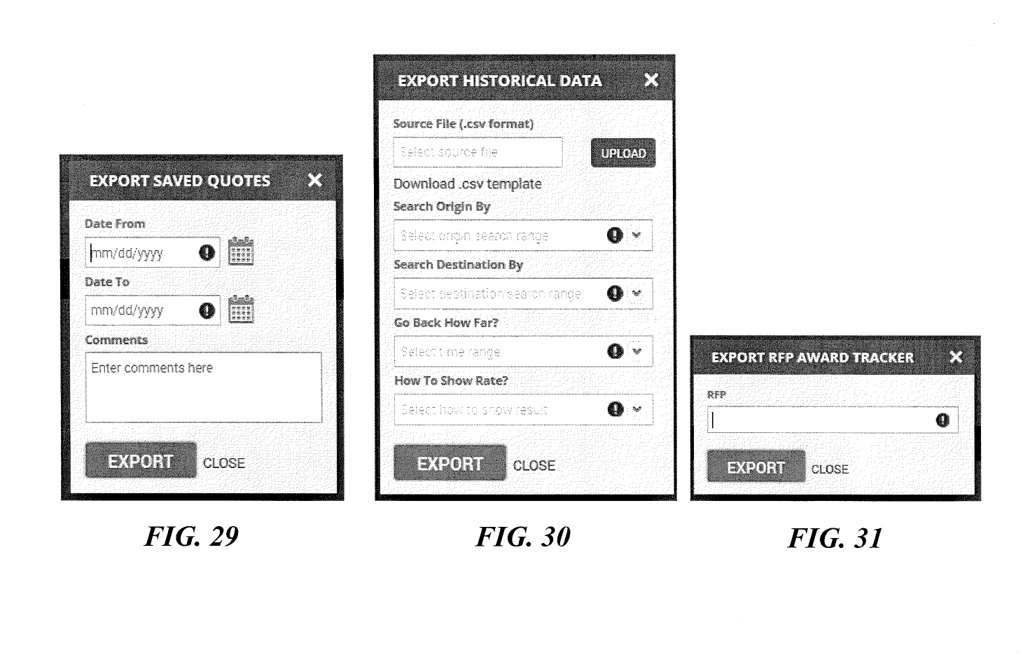

As will be set forth in greater detail with respect to FIGS. 2-41, the website provided by the central logistics system 16 may provider numerous functions, including soliciting, submitting, and accepting bids for particular shipments. To enhance bid solicitation and submission, the website may provide historical freight cost data, projected freight costs, and other data enabling goods providers 12 and freight providers 14 to tailor bids and requests.

The historical cost data repository 18 may be separate from the central logistics system 16, in an embodiment, such as in remote storage. For example, the remote storage may be Internet-accessible “cloud” storage, in an embodiment. The historical cost data repository 18 may be configured to store one or more of bids made and solicited through the central logistics system 16, shipping rate quotes from outside the central logistics system 16, and other data that may be useful to a goods provider 12 or freight provider 14 in determining appropriate costs for a given goods shipment.

The other sources of freight data 20 may be or may include one or more external sources of freight data including, but not limited to, rates. For example, the other sources of freight data may include external market rate sources (e.g., aggregated data regarding current and historical prevailing rates), websites of one or more carriers, and/or one or more other transportation management software services.

The website provided by the central logistics system 16 may also include a number of security and administrative functions to enable employees of goods providers 12 and freight providers 14 to act on behalf of their organizations. For example, the website may include certain features for limiting access to registered users. For example, the website may require a password and username for access.

FIG. 2 depicts an embodiment of a login page 22 for the website. As noted above, logging in to the website may require a username and a password which may be entered through respective username and password entry portions 24, 26, which username and password may be pre-registered with the website. The central logistics system 16 may be configured to verify that the username and password presented entitle a user to access the website, and may also determine which of a number of different user types are associated with the user.

The website provided by the central logistics system 16 may also provide different features for different user types. For example, a goods provider user type may be provided tools for soliciting bids for shipments, whereas a freight provider may be provided tools for submitting bids for shipments. In an embodiment, some users may have both abilities. Both goods providers and freight providers may be provided tools for comparing bids to historical freight costs, tracking and cataloging past bids made and received, forecasting future freight costs, a listing of available vehicles, and recommended freight routes. In addition, administrative users (for each of goods providers, freight providers, and the central logistics system 16 itself) may be provided with administrative tools.

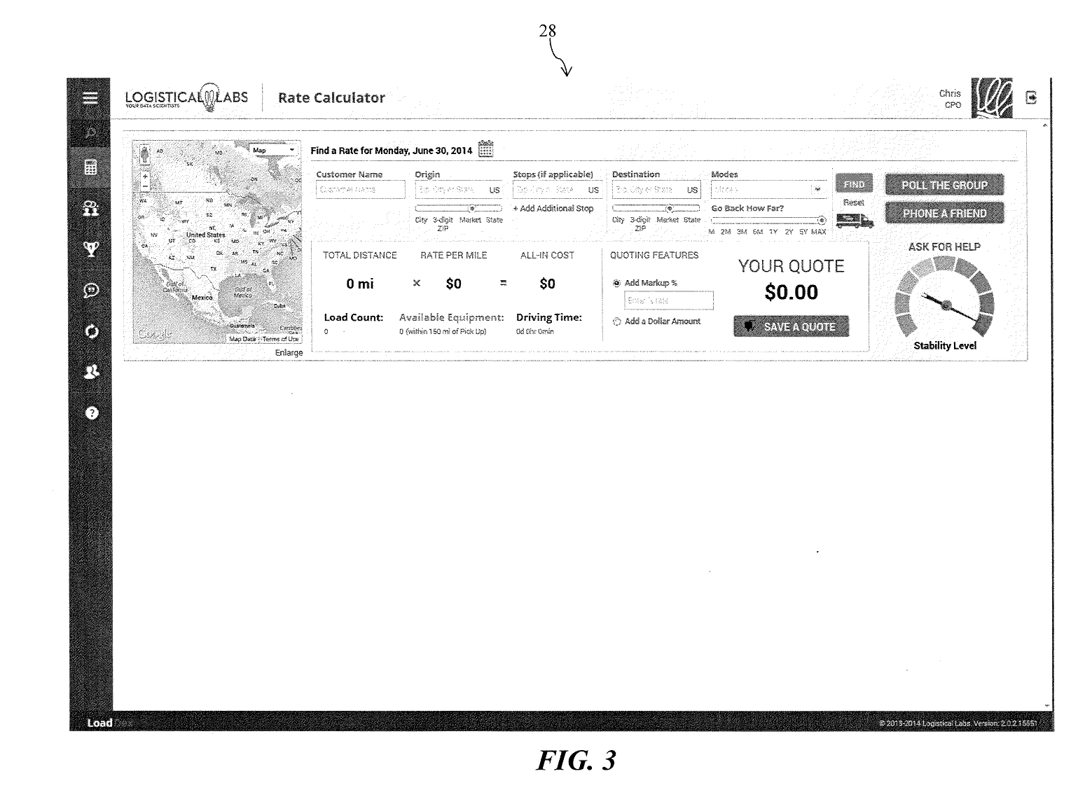

After verifying the user's login information, the website may present to the user a home page tailored to the user's user type. FIG. 3 depicts an exemplary home page 28 for a goods provider user type. From the home page, the goods provider user may have access to a number of different functions, including route mapping, predicted freight costs and stability of predicted freight costs, historical freights costs, bid solicitation, quote submission, and previous bid tracking.

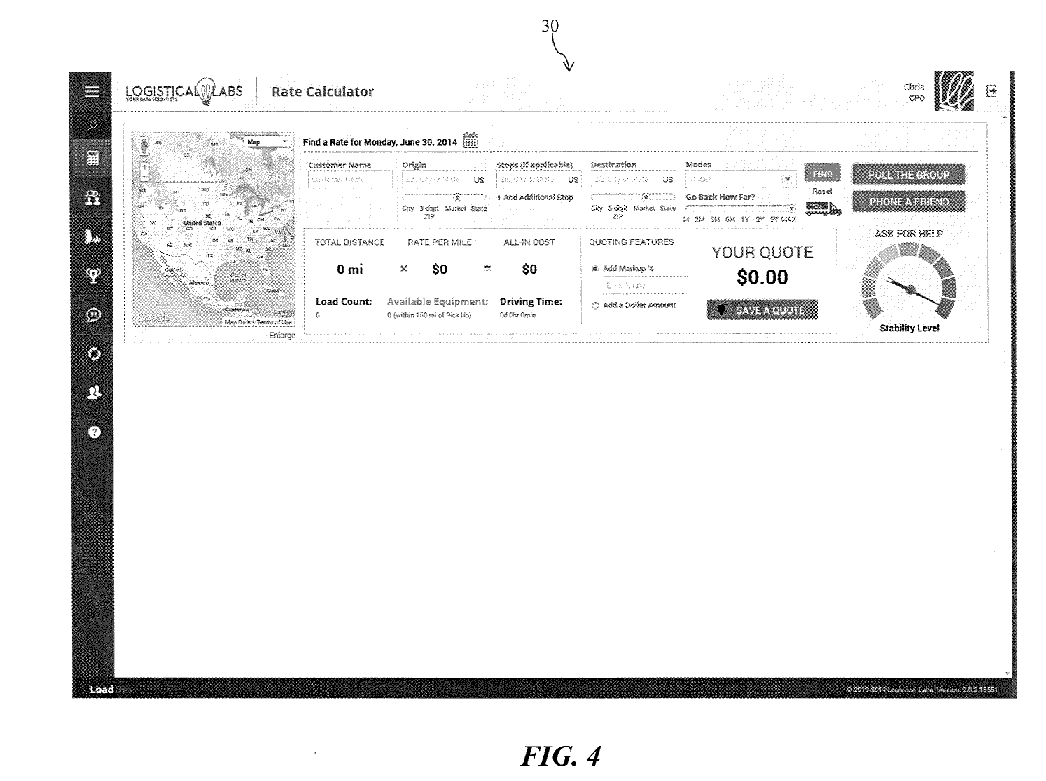

FIG. 4 depicts an exemplary home page 30 for a freight provider user type. The freight provider home page is similar to the goods provider home page, with many of the same functions provided. For example, like a goods provider, a freight provider may be provided with route mapping, predicted freight costs and stability of predicted freight costs, historical freights costs, and previous bid tracking. The freight provider may also be provided with tools for bid submission.

One or more users may additionally be enabled with user tools for administrative users, which tools may be linked from a home page 28, 30. For example, administrative users for freight providers and goods providers may be provided with data exchange tools for manually uploading batch data, and administrative users for the central logistics system 16 may be provided with additional administrative tools for adding, deleting, and editing companies, users, and other aspects of the website.

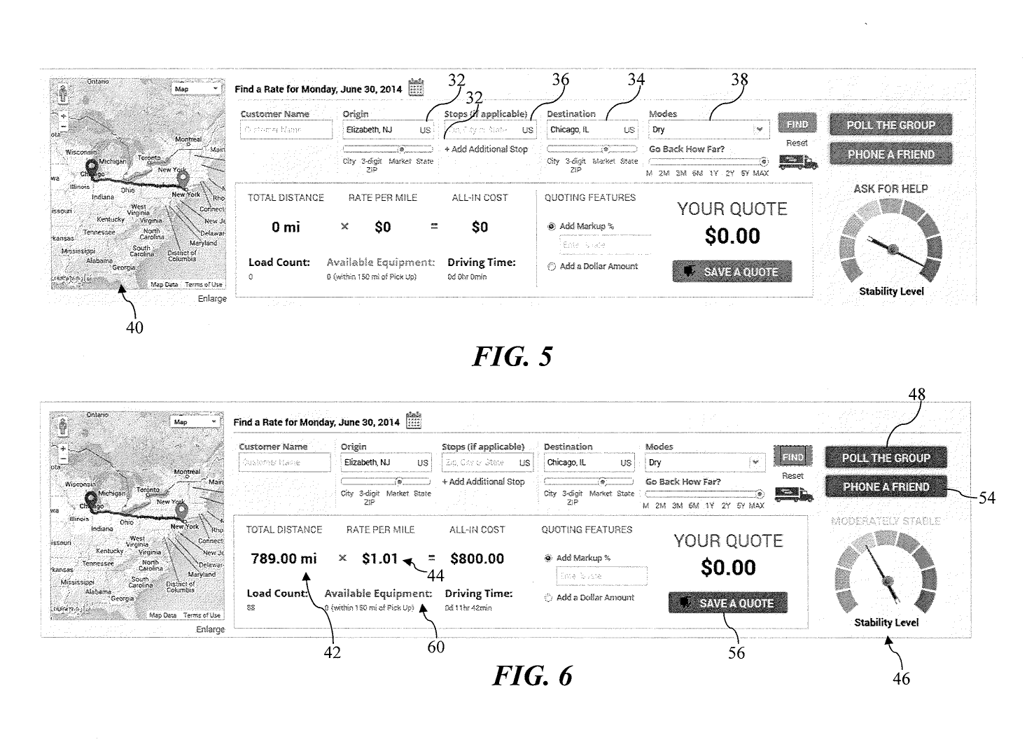

Both goods providers and freight providers may be provided with a route mapping tool on the homepage, illustrated in FIG. 5. The route mapping tool may accept an origin 32, a destination 34, one or more intermediate stops 36, and a transport mode 38 (e.g., dry load, intermodal, refrigerated). The route mapping tool may output a suggested route (e.g., via an interactive map 40) and a distance associated with that route, upon which predicted costs may be based, as described in greater detail below.

For the origin 32 and destination 34 of the goods, the route mapping tool may accept data in a number of different forms (i.e., of varying specificity). For example, in an embodiment, the route mapping tool may accept location information in the form of a city, a ZIP code (e.g., a five digit ZIP code, or the first three digits of a ZIP code), a market, or a state. The route mapping may be based on a predetermined exact location within the location specified by the user. For example, the route mapping tool may use the geographic center of a particular city, ZIP code, market, or state.

The route mapping tool may provide a discrete set of markets for selection by a user, if the user wishes to determine a route according to one or more markets. A market may correspond to, in an embodiment, a defined portion of a state (or multiple states), a defined geographic area around a city center (e.g., Chicago, Indianapolis, etc.). Market definitions may also take into account locations of known freight hubs, population densities and distributions, warehouse locations, etc.

FIG. 6 depicts an exemplary implementation of predicted freight costs and stability of predicted freight costs and quote submission. The predicted freight costs may be calculated according to the total distance 42 determined by the route mapping tool and a predicted rate per mile 44. The predicted rate per mile 44 may be specifically tailored to the specified route—i.e., the rate per mile 44 may be different for a shipment from Tucson to Seattle than for a shipment from Boston to Charlotte.

The predicted rate 44 may be calculated in a number of different ways. In an embodiment, the predicted rate 44 may be calculated according to a simple average of previous freight rates for a given route and time period. The time period may be specified by the user, in an embodiment, through a slider or other input on the webpage. In another embodiment, the predicted rate 44 may be calculated according to a multiple regression analysis of previous freight rates. The multiple regression analysis may consider a number of different variables including, but not limited to, transit mode, time of year (e.g., month, week, season), time of day, weather (e.g., presence or absence of severe weather along the freight route), aspects of the ship date and transit time (e.g., weekdays v. weekends, proximity to holidays and ends of months, lead time between bid or quote submission and the ship date), number of extra stops, commodity carried, pick up or delivery warehouse, customer, motor carrier (MC) number of the carrier, and/or the regions included in the freight route. The multiple regression analysis may weigh different variables differently, in an embodiment. For example, variables related to a specific carrier's historical data may account for 70% of the total weight, and broader market information may account for 30% of the total weight.

The predicted rate stability 46 may indicate the likelihood that a predicted rate 44 will correlate with an actual cost, will remain the predicted rate for a period of time, or some other stability factor. The predicted rate stability 46 may be calculated according to previous rates for a particular freight route (again, in an embodiment, for a time period specified by the user). More specifically, the predicted rate stability may be calculated according to variations in previous rates for a particular freight route such as, for example, probability ranges (as discussed below), time-based trends, or and/or other metrics.

In an exemplary embodiment of determining rate stability 46, a probability range may be used. Such a probability range may be constructed by arranging (e.g., in ascending order), past rates for a given freight route. A number N of rates may be used. A probability may be associated with each of those rates, with the probability indicating the likelihood that any rate in the table would be equal to or less than the rate Rₚ, p=1, . . . N, with which the probability is associated. Such probabilities may be computed according to equation (1) below:

$$100 * ( ( \frac{p}{N} ) - ( \frac{1}{2 N} ) ) \qquad ( Eq . 1 )$$

To determine stability, all but some of the highest and lowest probabilities (i.e., the rates associated with those probabilities) may be examined. For example, the highest 12.5% and lowest 12.5% rates may be discarded (i.e., any rate associated with a probability over 87.5% or under 12.5%), so that the middle 75% (which may be more indicative of stability than if upper and lower outliers were included) may be examined. In an embodiment, the cost difference between the top of that 75% and the bottom of that 75% (e.g., in terms of dollars, percentage, etc.) may be used to determine stability. As that difference goes up, stability may go down, and vice-versa. In an embodiment, the difference may be compared to one or more thresholds, each threshold associated with a particular stability level. For example, the indicator shown in FIG. 6 includes nine (9) discrete stability levels. Each of those nine (9) stability levels may be associated with a particular threshold.

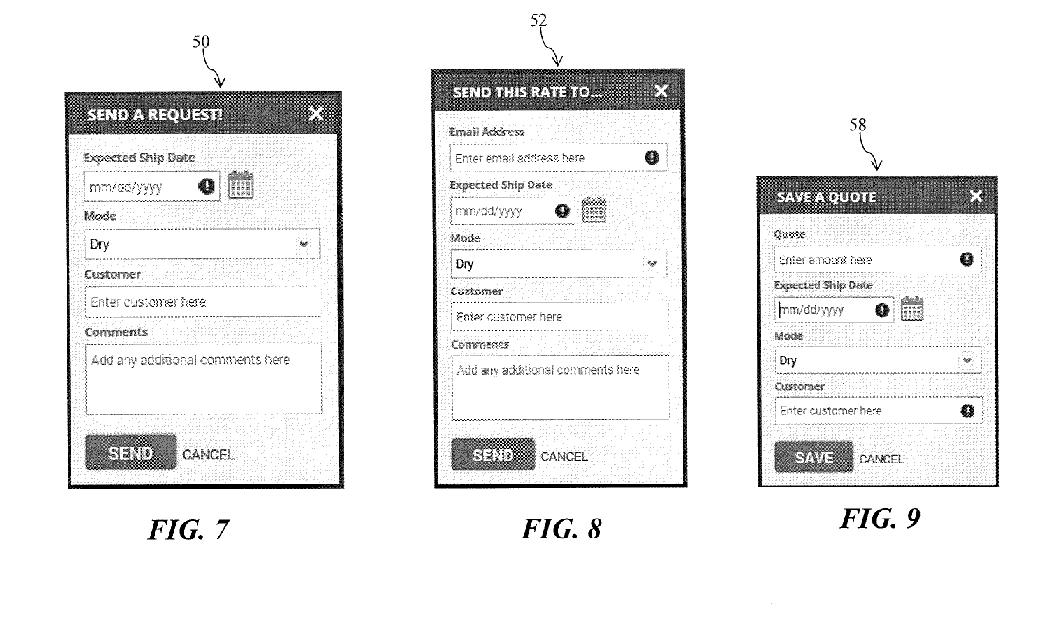

The goods provider may also have access to tools for soliciting bids, as noted above. FIGS. 7 and 8 depict exemplary embodiments of two such tools. FIG. 7 depicts a group rate request interface 50 that may be accessed through the “Poll the Group” button 48 in FIG. 6. The group rate request may allow the user to send a rate request (or other inquiry) to a specified group of freight providers. The group may include, for example, freight providers with which the user has done business in the past, freight providers associated with a particular city, ZIP, state, or region, or another grouping.

FIG. 8 depicts an individual rate request interface 52 that may be accessed through the “Phone a Friend” button 54 in FIG. 6. The individual rate request may allow the user to send a rate request (or other inquiry) to a specific freight provider.

Based on the information available to the goods provider user, the user may save a quote for acceptance by one or more freight providers. The quote may be calculated according to the predicted rate tool, along with a desired markup (e.g., percentage or dollar amount). Entering quote information and selecting the “Save A Quote” button 56 may result in the menu 58 in FIG. 9.

Referring to FIG. 1, quotes, messages, and other information exchanged between goods providers and freight providers may be received by the central logistics system 16 and forwarded to the intended recipient. Furthermore, the central logistics system 16 and/or the historical freight data repository may store some or all of the data accessible through the website described herein.

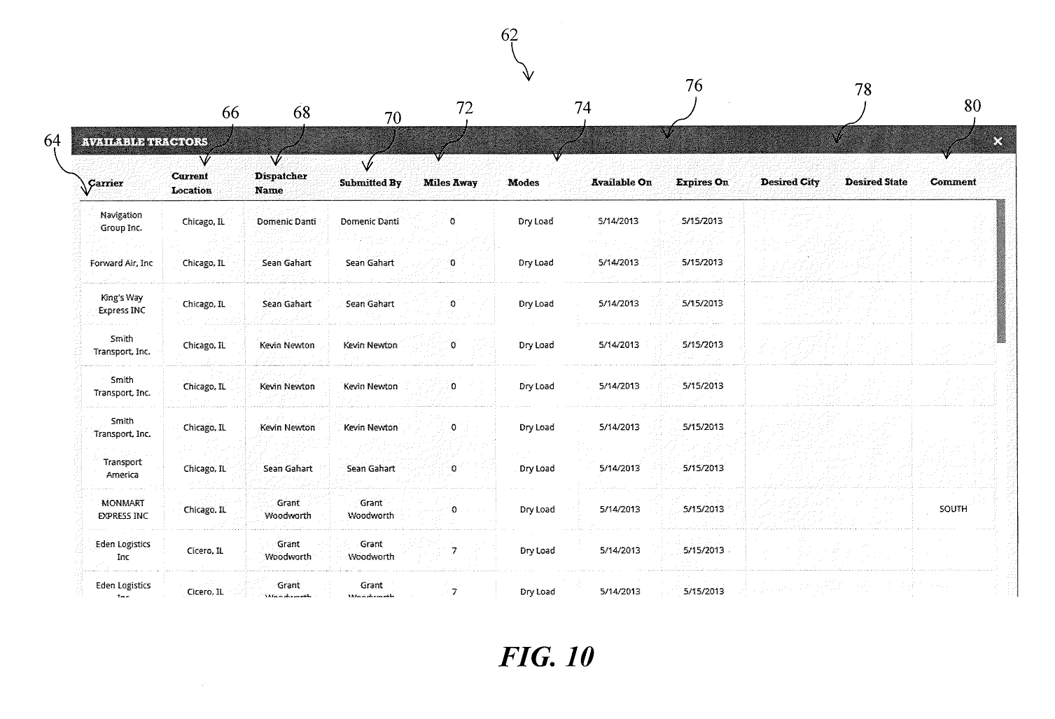

FIG. 10 depicts an exemplary listing 62 of available tractors that a user may access through the “Available Equipment” button or link 60 in FIG. 6. The listing 62 of available tractors may include all tractors within a certain distance of a given location (e.g., city, ZIP, state, region) and may list various information about those tractors. For example, carrier 64, current location 66, dispatcher name 68, submitter 70, distance from a given location 72, freight modes 74, availability dates 76, a desired location 78 (e.g., city, state), and comments 80 may be provided for each tractor.

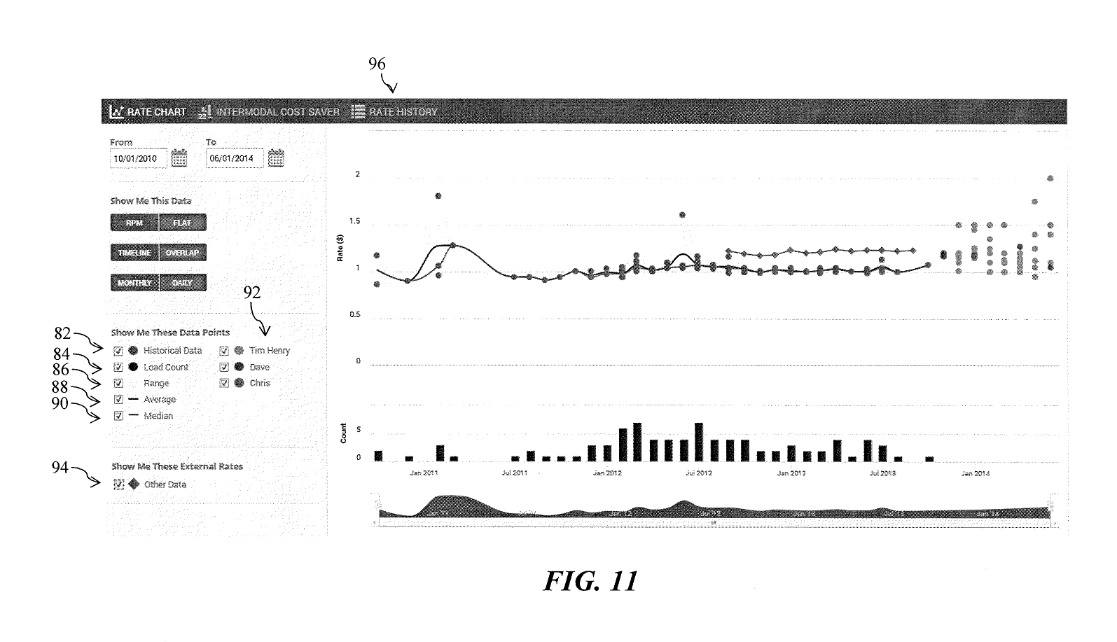

FIG. 11 depicts an exemplary interactive plot of historical freight costs that may be provided to a user of the website. The plot may enable the user the user to view a variety of data, according to a variety of criteria. For example, the plot may include, at the user's options, historical freight costs 82 (e.g., in rate per mile or total rate) for a given route over a given time period, a load count 84 for samples within that time period, ranges of freight costs 86 for portions of the time period, average 88 and median 90 cost data, and costs respective of specific freight providers 92. The plot may also include data 94 from, for example, external market data sources, data resulting from a group rate request (e.g., according to the “Poll the Group” feature referenced above), and/or other data.

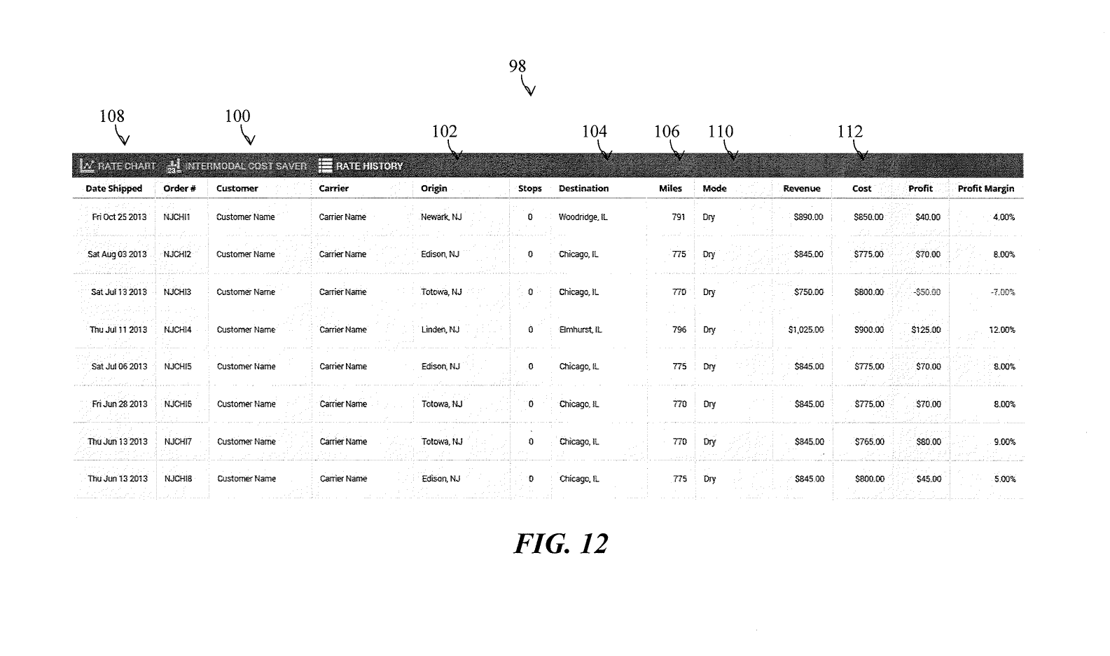

The interactive plot also allows the user to view the data underlying the plot by selecting the “Rate History” button 96. An exemplary detailed rate history 98 is depicted in FIG. 12. The rate history may include various information regarding each shipment, such as a customer 100, origin 102, destination 104, distance 106, date 108, mode 110, cost 112, and/or other information.

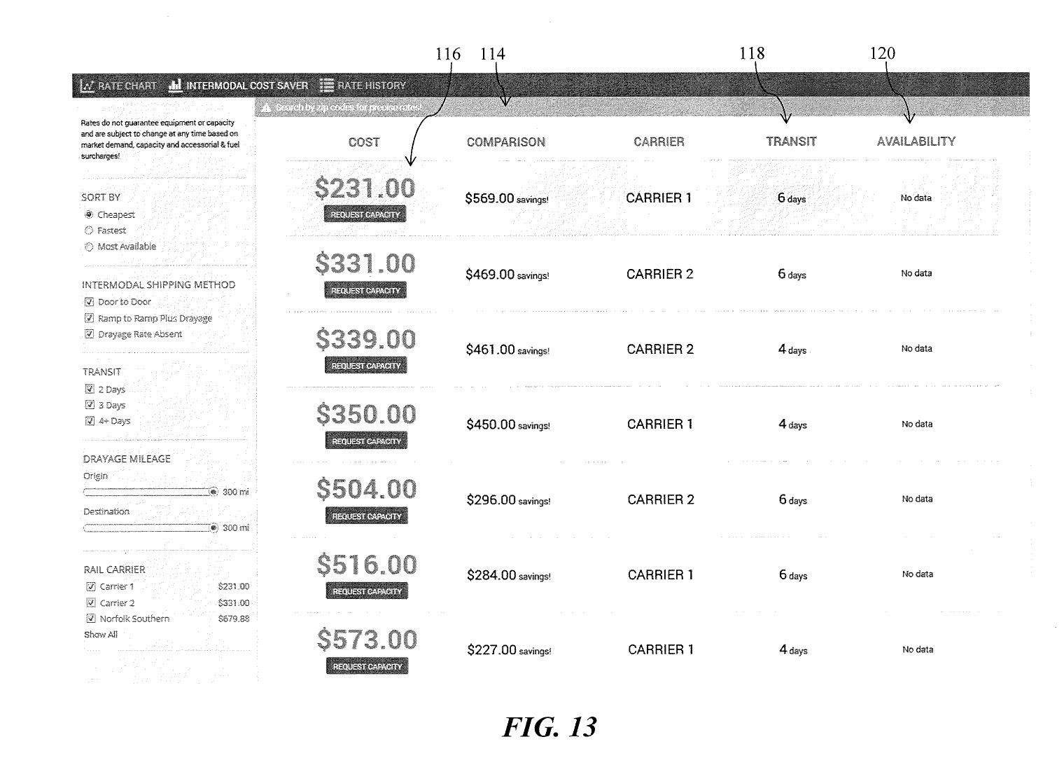

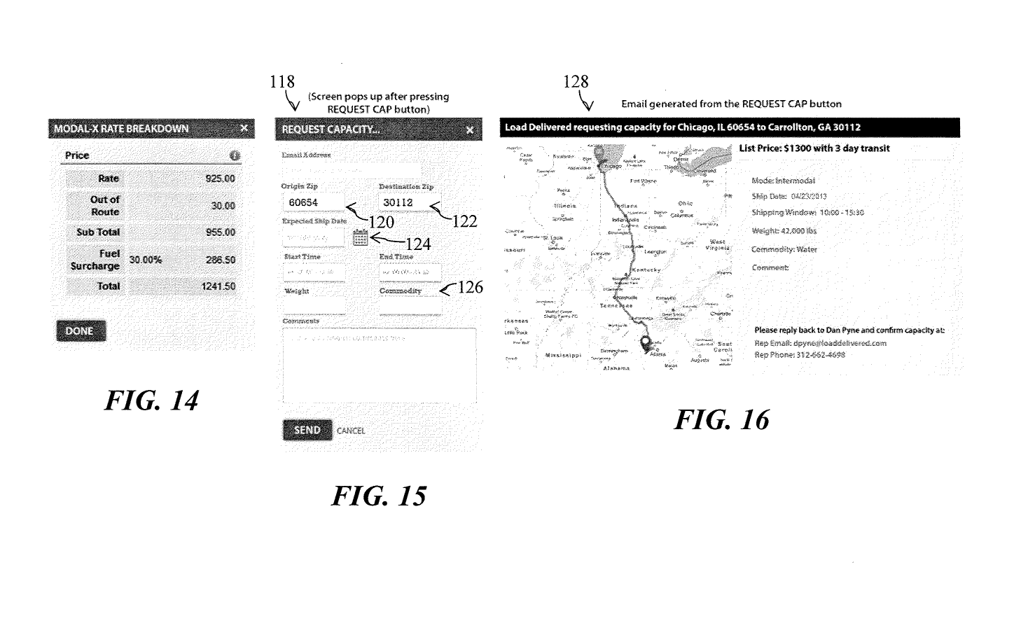

In addition to rates and quotes from freight providers that use the website, the website may provide freight cost data respective of other common carriers, as shown in FIG. 13. The costs 114 from the common carriers may be compared to the predicted cost (e.g., in a dollar amount comparison 116). Other information respective of the common carriers rates may be provided, such as a predicted transit time 118, container availability 120, etc. In addition, by selecting a given rate, the exemplary display of FIG. 14 may be presented.

Through the common carrier rate display, a user may also be able to access a capacity request interface 118, an exemplary embodiment of which is shown in FIG. 15. The capacity request interface 118 may allow a goods provider user to specify an origin 120, destination 122, date 124, and information 126 about the goods to be shipped (e.g., weight, commodity) for the goods provider to solicit information from the common carrier regarding its capacity. The common carrier may receive a message 128, an exemplary embodiment of which is shown in FIG. 16, including the information provided by the goods provider. The message may be generated and delivered by the central logistics system 16, in an embodiment.

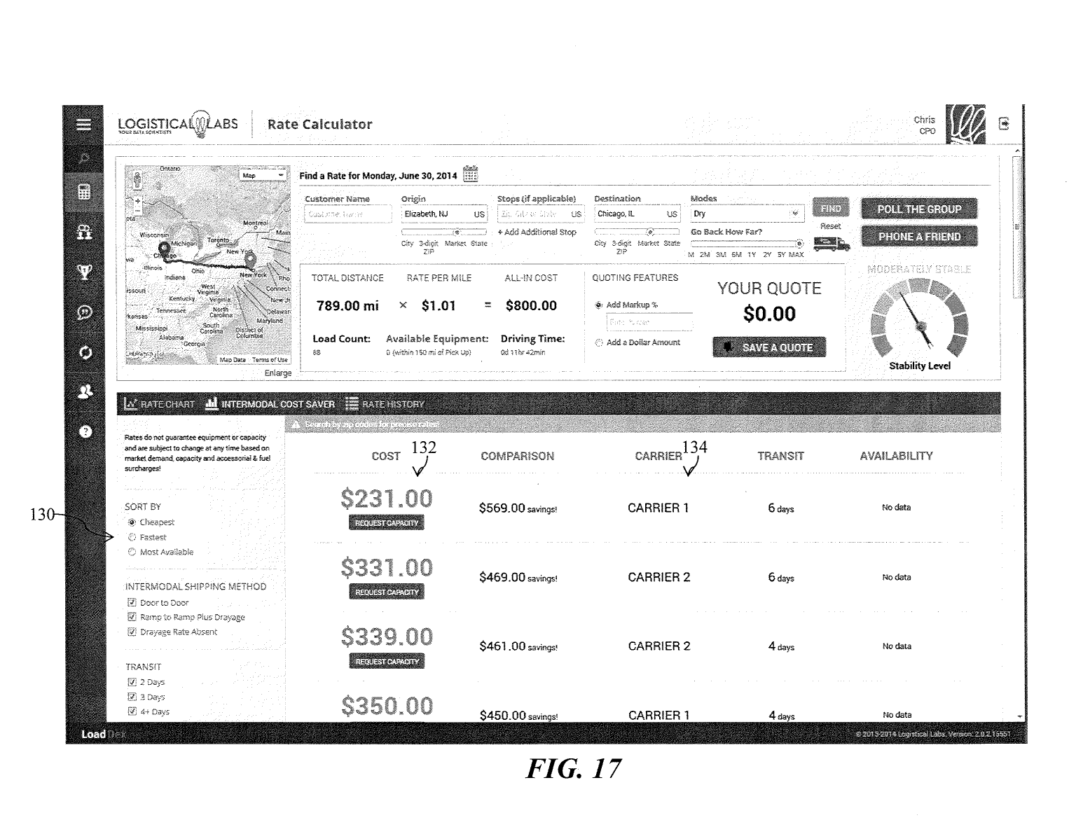

A user may also be provided an “intermodal cost saver” tool 130 through the website. An exemplary embodiment of the intermodal cost saver tool 130 is shown in FIG. 17 (though features of an embodiment of the intermodal cost saver tool may include, e.g., the features illustrated in and described with respect to FIGS. 13-16). The intermodal cost saver tool 130 may include, in an embodiment, a listing of different intermodal rates 132, the modes associated with those rates (not shown in FIG. 17), the distances associated with those modes (not shown in FIG. 17), and the carriers 134 providing those modes.

In an embodiment, the intermodal cost saver tool may break down intermodal shipments into their component parts (in the main menu view, or in a secondary detailed view), indicate the details of each part (i.e., mode, rate, distance, origin, destination), and compare the respective costs of the entire intermodal shipment, the component parts of the intermodal shipment, and the rate quotes from users of the website (which may be over-the-road rates, in an embodiment). For example, in an embodiment, a given shipment may be possible from the door of the shipping business to the door of the recipient business (i.e., door-to-door) using a combination of rail and dray. In such an embodiment, the intermodal cost saver tool may provide both door-to-door rates and ramp-to-ramp rates (with ramp-to-ramp excluding dray, for example). Distances from the origin or destination of a particular mode (e.g., from the rail origin and destination) to the origin and destination of the shipped goods may also be indicated.

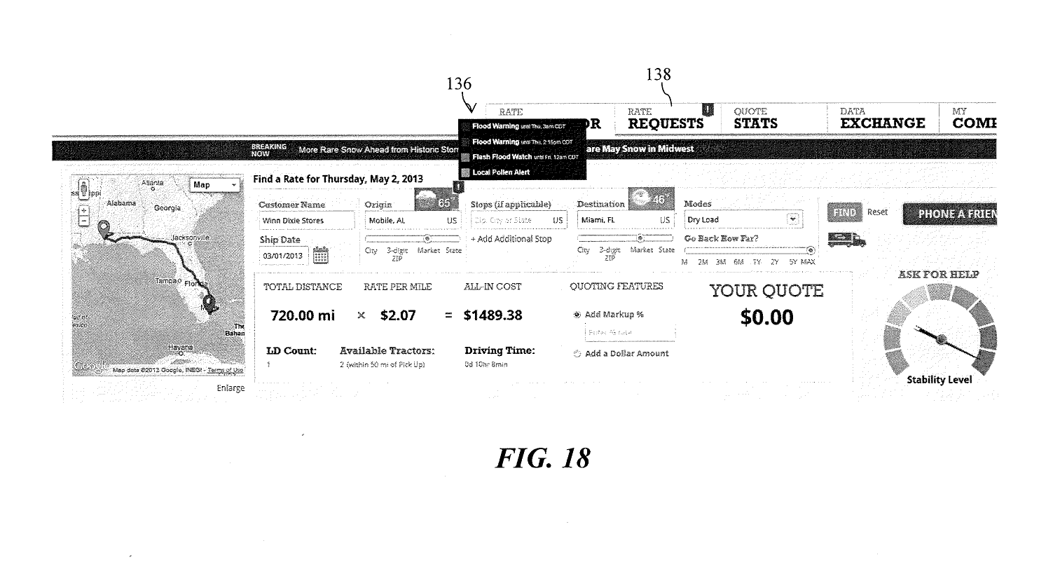

As noted above, rates may be affected by weather conditions in the freight route. Accordingly, as shown in FIG. 18, the website may provide indications 136 of severe weather along a freight route provided by a user for dates provided by a user.

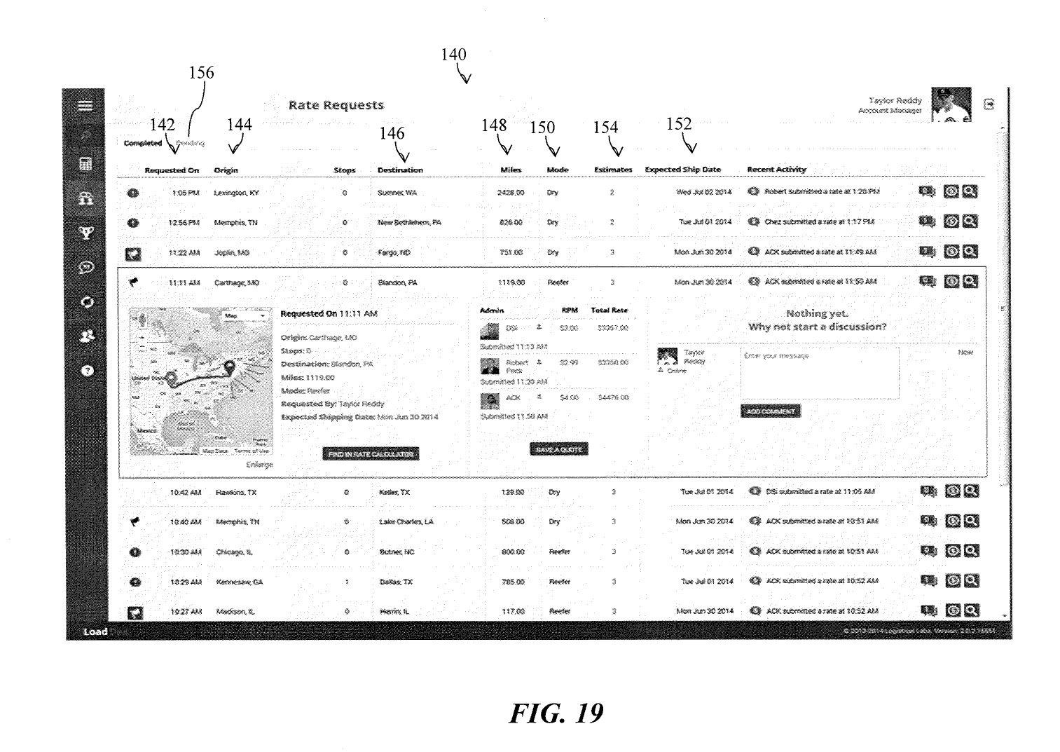

One of the functions that may be provided to both goods providers and freight providers is a listing of previous rate requests, through the rate requests tab 138 shown in FIG. 18. Different rate requests pages may be provided by goods providers than for freight providers. Referring to FIG. 19, the goods providers rate requests page 140 of the website may include information respective of past rate requests, such as the date and/or time of the request 142, the origin 144, destination 146, distance 148, transit mode 150, and expected shipping date 152 for the shipment, as well as the number of estimates 154 that have been provided responsive to the request. Each rate request to which a user was a party may be visible to that user. Thus, for goods providers users, each rate request submitted by that user or by that user's company may be visible to the user. By selecting the “Pending” tab 156, a goods provider may be able to view rate requests for which a freight provider has not yet been selected.

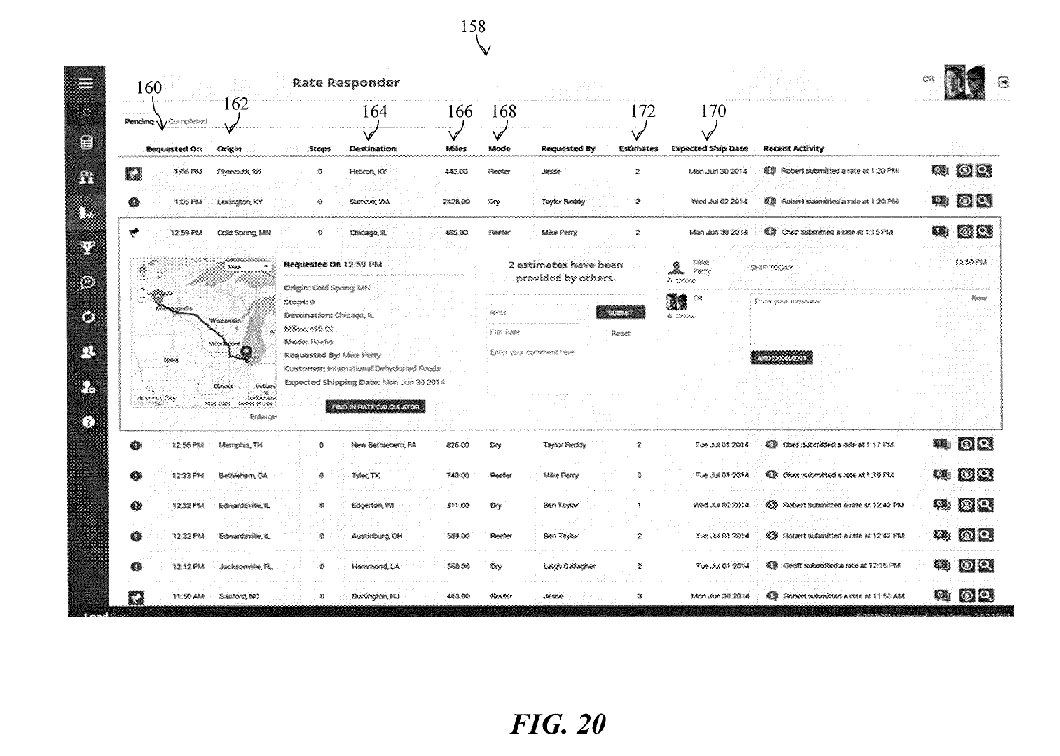

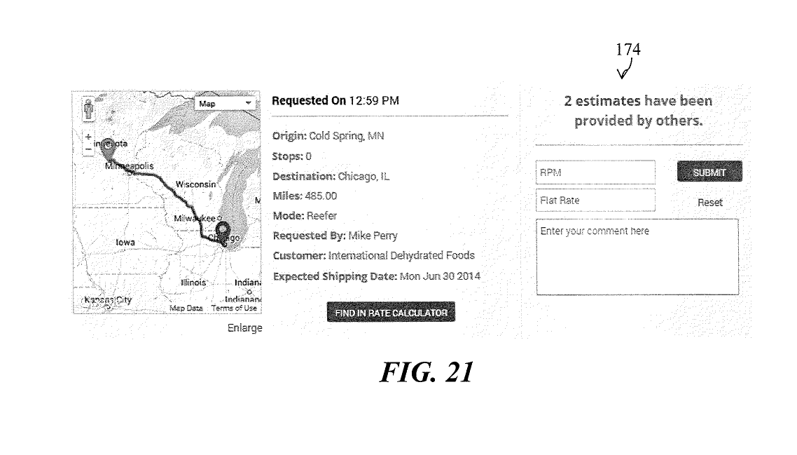

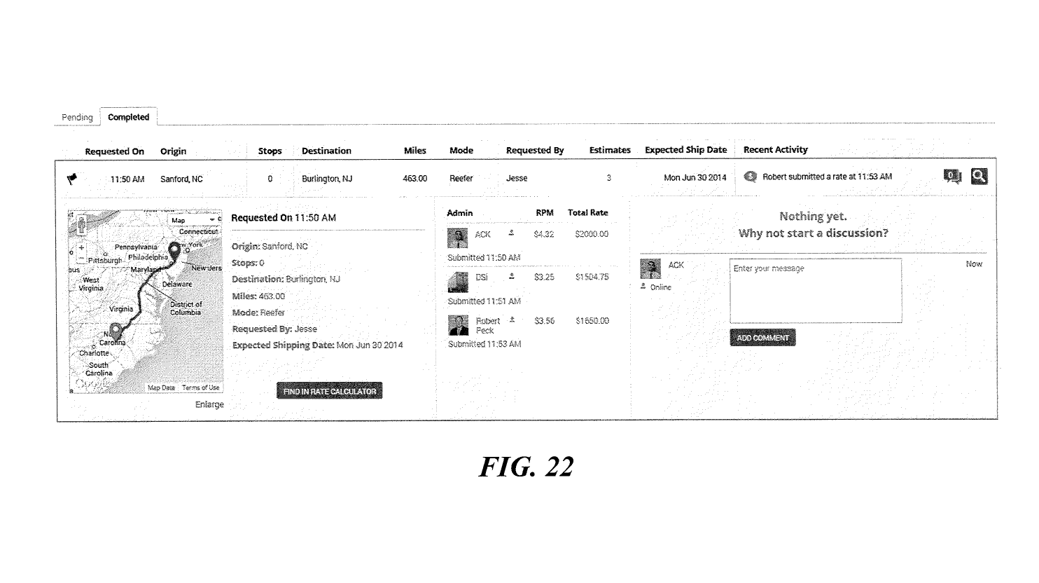

FIG. 20 illustrates an exemplary rate requests page 158 for a freight provider. For freight provider users, each rate request submitted to the user or the user's company may be visible. Information respective of past rate requests, such as the date and/or time 160 of the request, the origin 162, destination 164, distance 166, transit mode 168, and expected shipping date for the shipment 170, as well as the number of estimates 172 that have been provided responsive to the request may all be listed, as well as the estimate provided by the user or the user's company, if available. As shown in FIGS. 20 and 21, a user may select a particular rate request, in response to which the request may be expanded to provide further information about the request, as well as an interface 174 through which the user may submit an estimate responsive to the request.

A freight provider may also be able to view submitted bids for which the freight provider has responded to the goods provider by selecting the “Completed” tab. An exemplary “Completed” page is shown in FIG. 22.

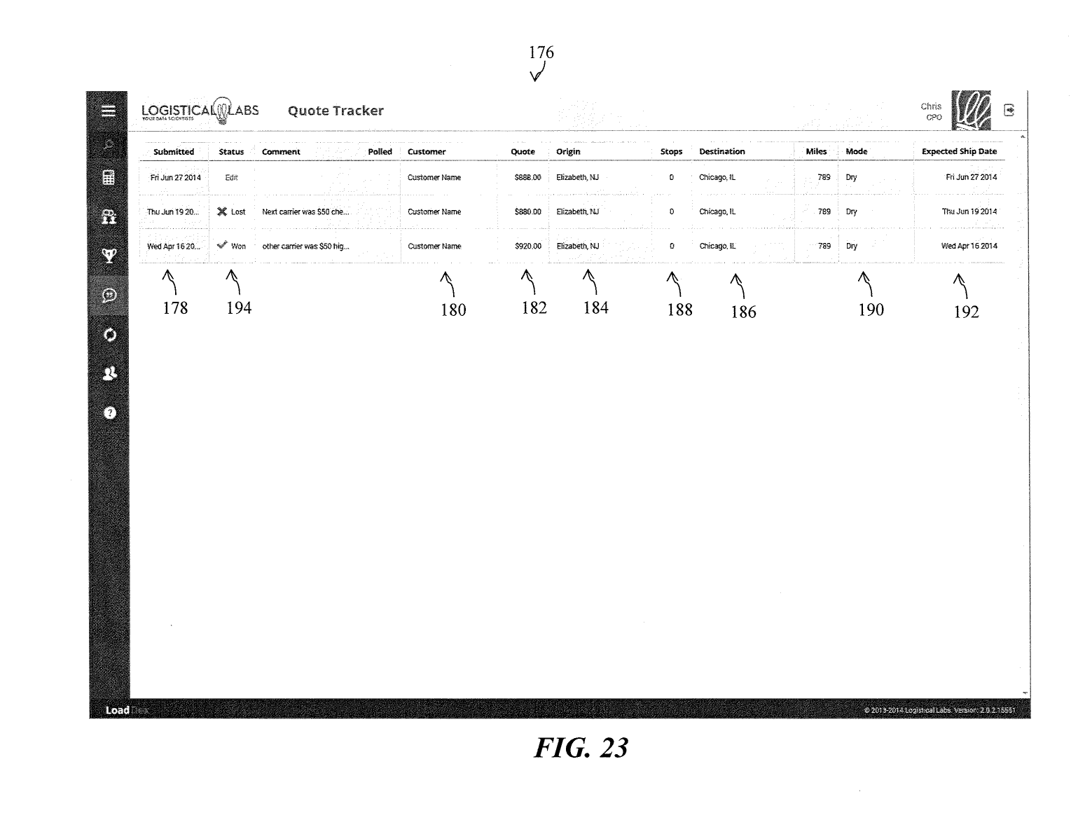

FIG. 23 depicts an exemplary quote tracking feature 176. The quote tracker page may include a listing of each quote in which the user or user's company is presently involved in or was involved in for a given time period. The quote tracker page may enable the user to enter and store notes for individual quotes for use in developing future quotes. Pertinent information for each quote may be provided, such as submission date 178, customer 180, quote amount 182, origin 184, destination 186, number of stops 188, transit modes 190, and expected ship date 192 may all be listed, along with the status of the quote (e.g., won, lost) 194. Thus, the quote tracker 176 may provide a consolidated list of each quote in which a user or company is or was actively involved for easy access and review.

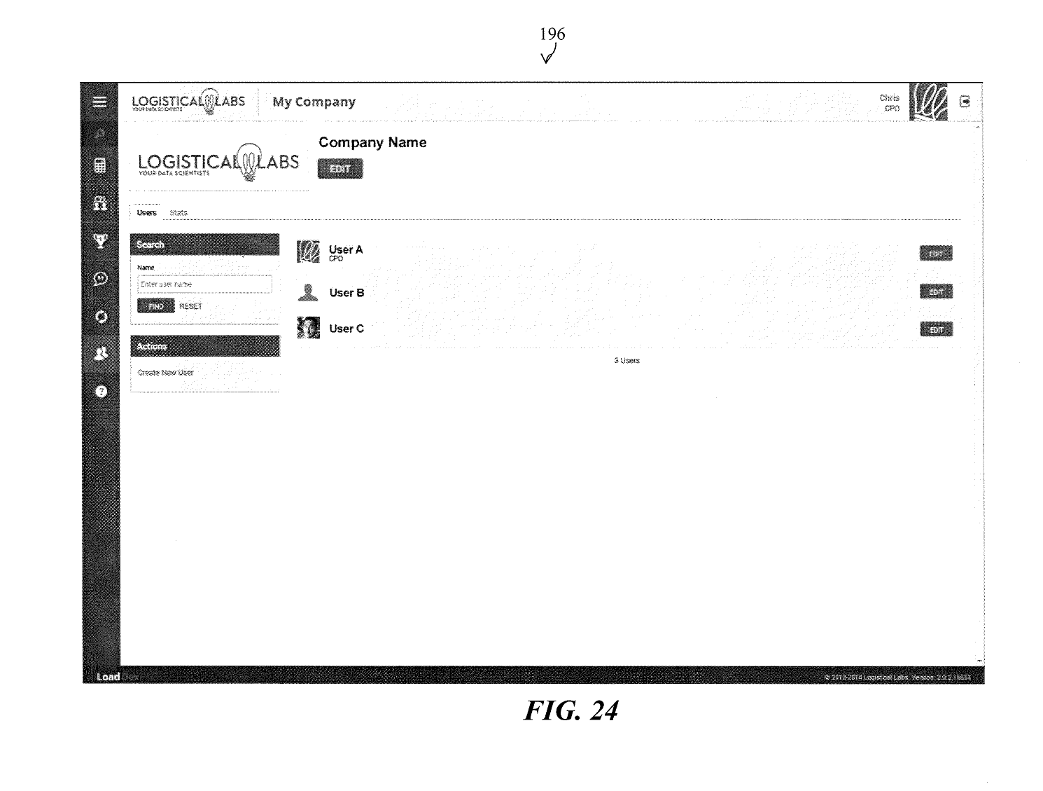

FIG. 24 depicts an exemplary company information feature 196. Through the company information feature 196, a user may find, add, remove, and edit users associated with that company. Edit privileges may be restricted to users with administrative rights for that particular company, in an embodiment.

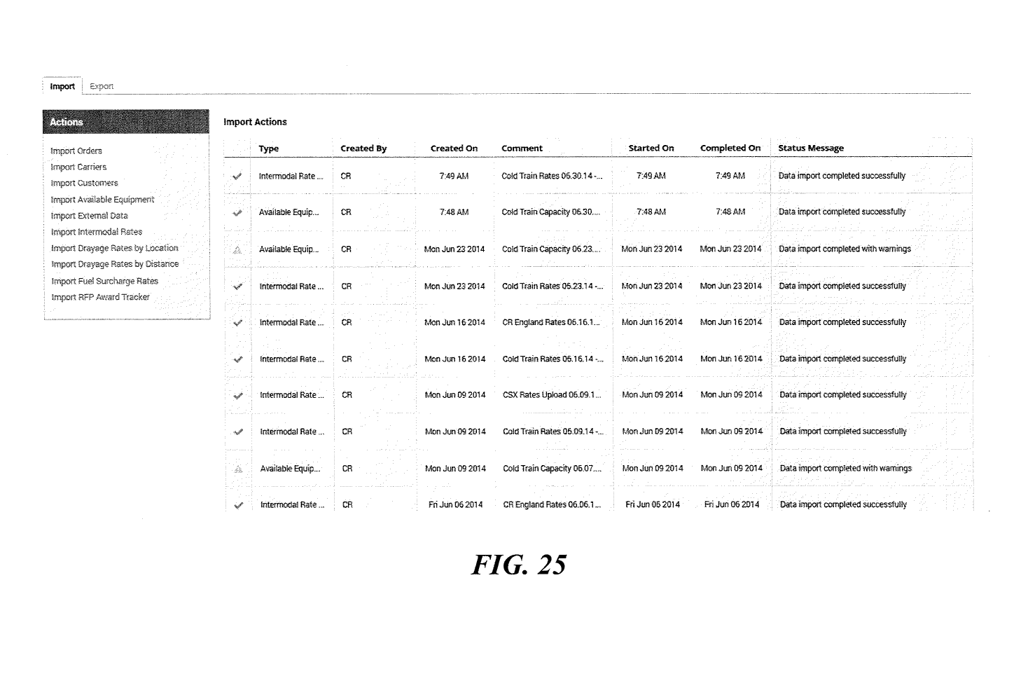

FIGS. 25-31 illustrate a data exchange feature that may be provided to administrative users, in an embodiment. The data exchange feature may enable an administrative user to batch upload or download data respective of a user, company, common carrier, available tractors, past orders, and other information that may be useful to store in a centralized manner to enable future rate determinations. Data uploaded through the data exchange feature may be received by the central logistics system 16 and stored in the historical freight data repository, in an embodiment.

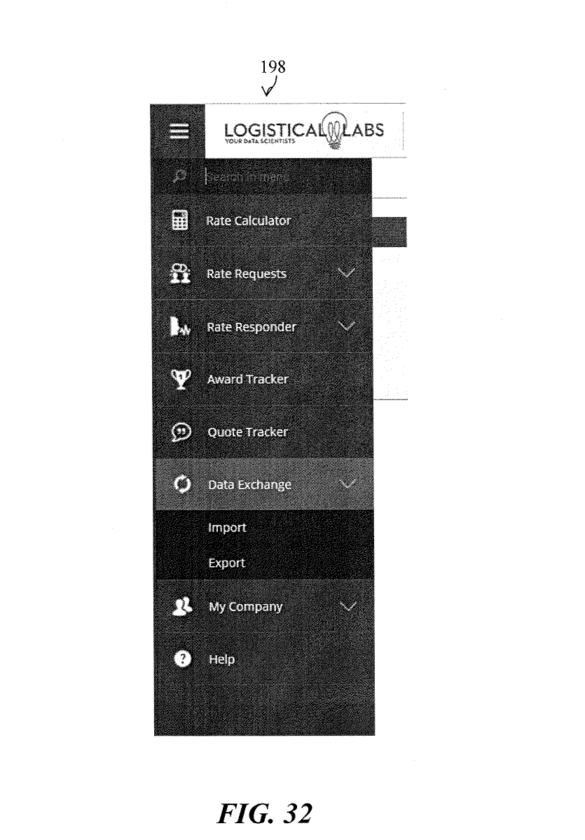

As described and illustrated herein, a number of different menu types and styles may find use in the website. For example, FIG. 32 depicts an exemplary drop-down menu 198 that may be used with a rating tool. Of course, numerous types of menus may be used.

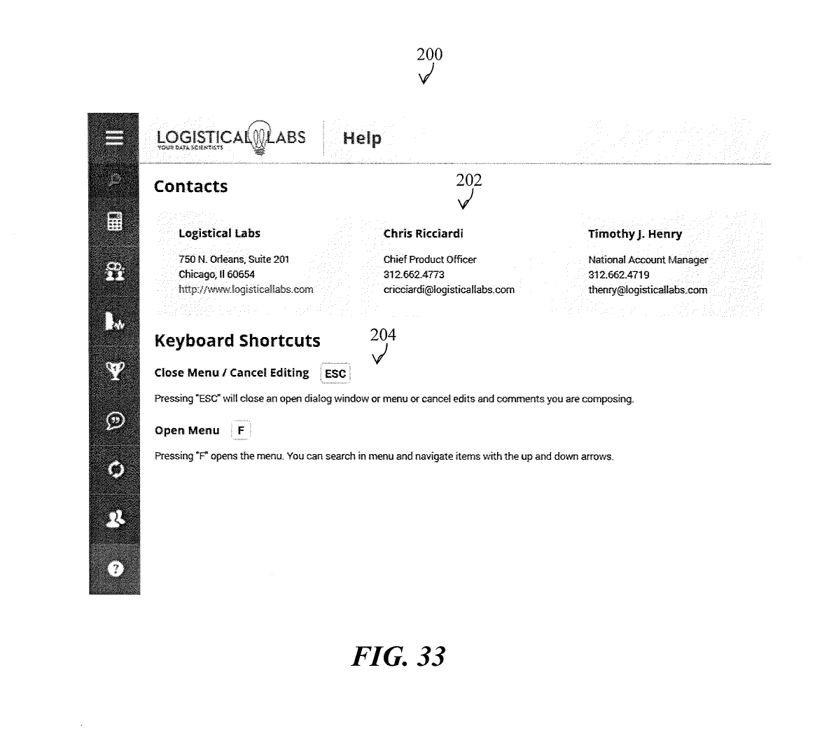

As with many websites and software-based tools and services, the website may include a “Help” tool. FIG. 33 depicts an exemplary “Help” page 200. Among other things, the “Help” tool of the website may provide contact information 202 for the website proprietor, keyboard shortcuts 204 and/or other tips for interacting with the website, and/or other features intended to aid a user's interaction with the website.

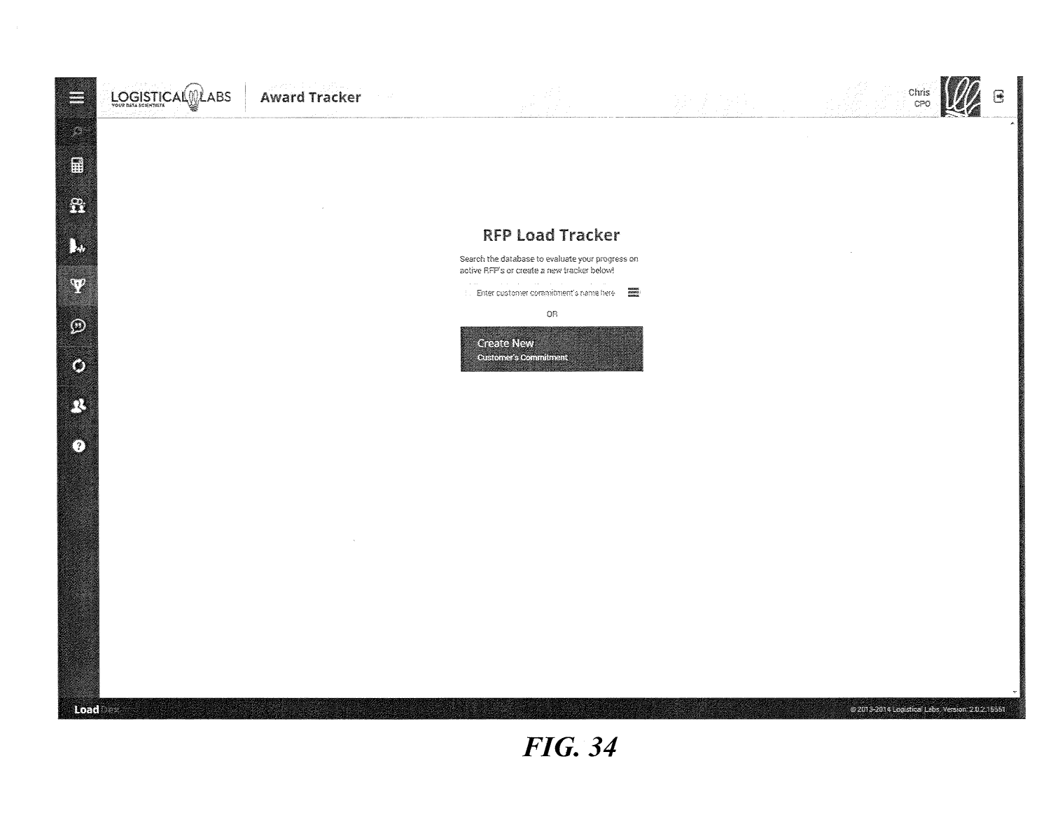

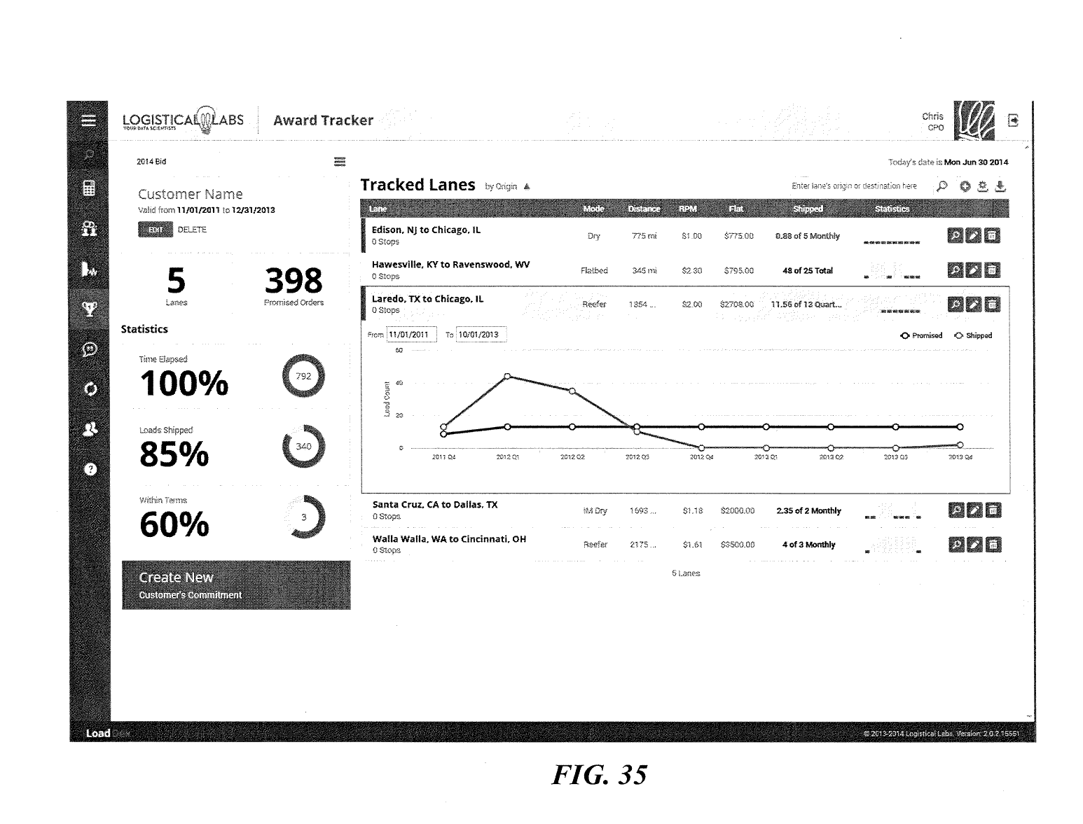

FIGS. 34-35 depict exemplary pages to track contracted freight rates. For example, as shown in FIG. 34, a carrier may search for contracted rates by customer name. Additionally or alternatively, the website may enable a carrier to search for contracted rates by other shipment features, such as mode, date, day of week, origin, destination, and/or other data associated with a shipment noted herein. As shown in FIG. 35, search results may be provided in an integrated text-and-graphic page, in an embodiment. Additionally or alternatively, a user may be able to select numerous rates as “tracked,” and tracked rates may be displayed in a text-and-graphic page such as the one illustrated in FIG. 35.

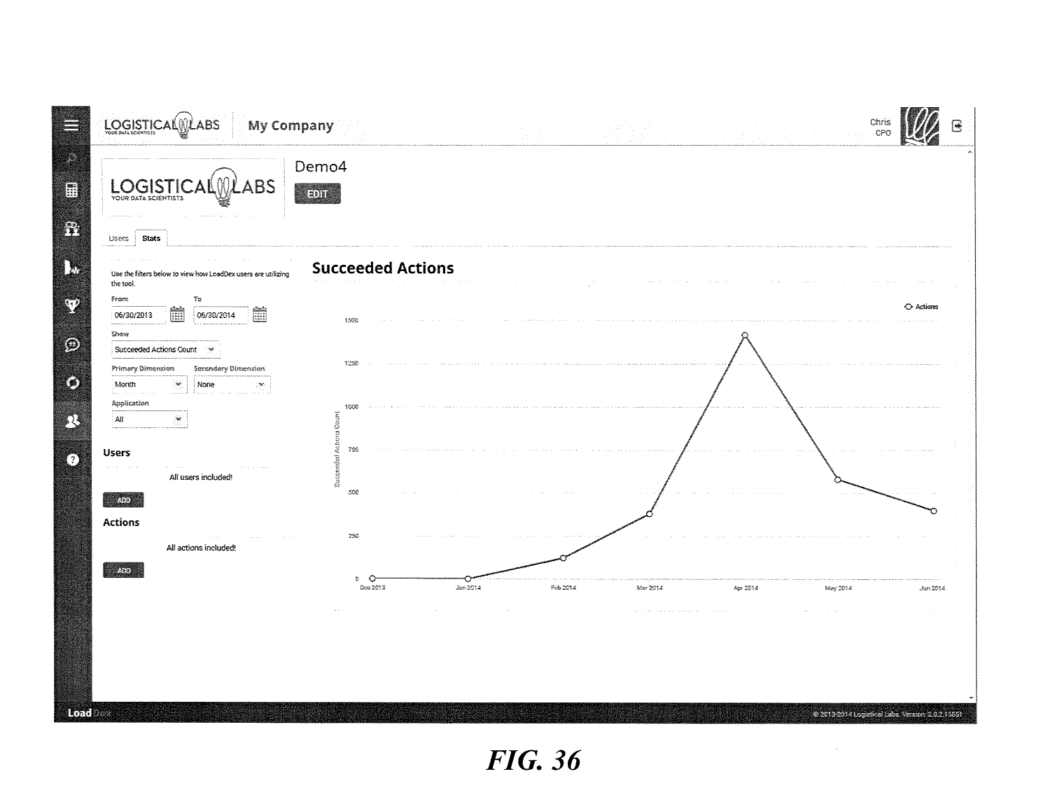

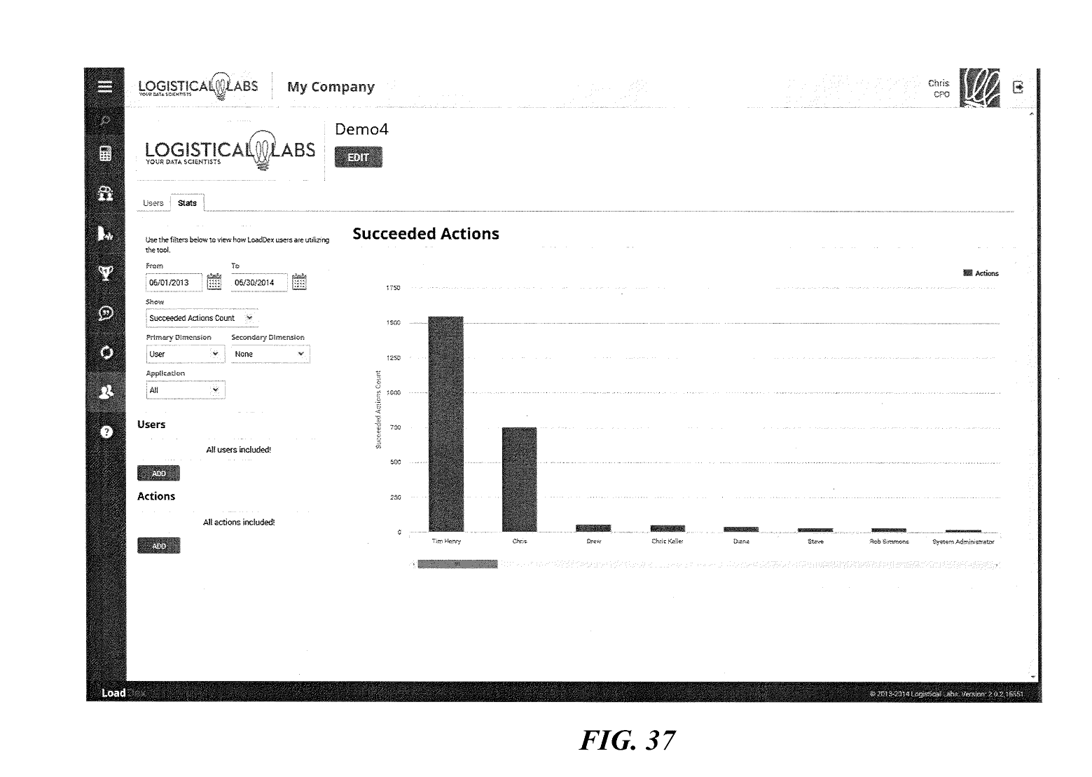

The website may track the in-website activity of one or more users, in an embodiment. FIGS. 36-37 depict exemplary pages of tracked usage of multiple users of the website. The website may provide the ability for a particular user's activity and usage to be viewed for a given time period (as shown in FIG. 36), and for numerous user's activity to be compared with each other (as shown in FIG. 37).

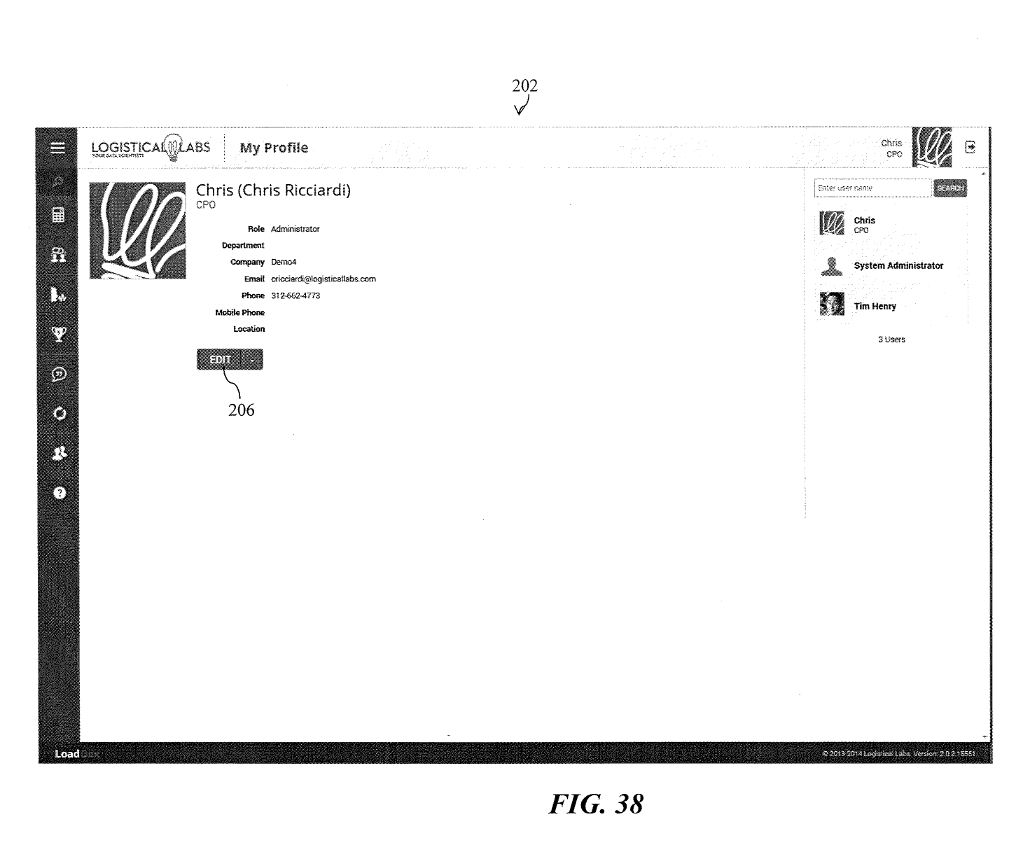

Each user of the website may have an individual account and profile, in an embodiment. FIGS. 38-40 depict exemplary pages to view and edit a user's profile. As shown in FIG. 38, a user's profile 202 may include, among other things, a role, a department, a company, an email address, one or more phone numbers, and a location. A user (and/or an administrator) may be able to edit a user's profile through the “Edit” button shown in FIG. 38.

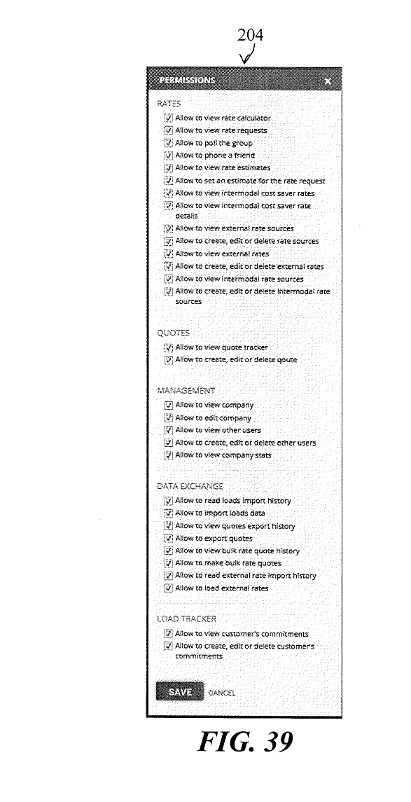

FIG. 39 illustrates a permissions feature. Each user profile may be associated with a set of permissions that may govern which portions of the website a given user may be exposed to (i.e., which features a given user can use). Permissions may be different for different roles within a company. For example, a master user of a company (e.g., a carrier) may have permission to edit the company profile, to view company stats, etc., which abilities a user with less responsibility may not have. Furthermore, some features may be exposed only to website administrators, in an embodiment. Exemplary permissions 204 are illustrated in FIG. 39.

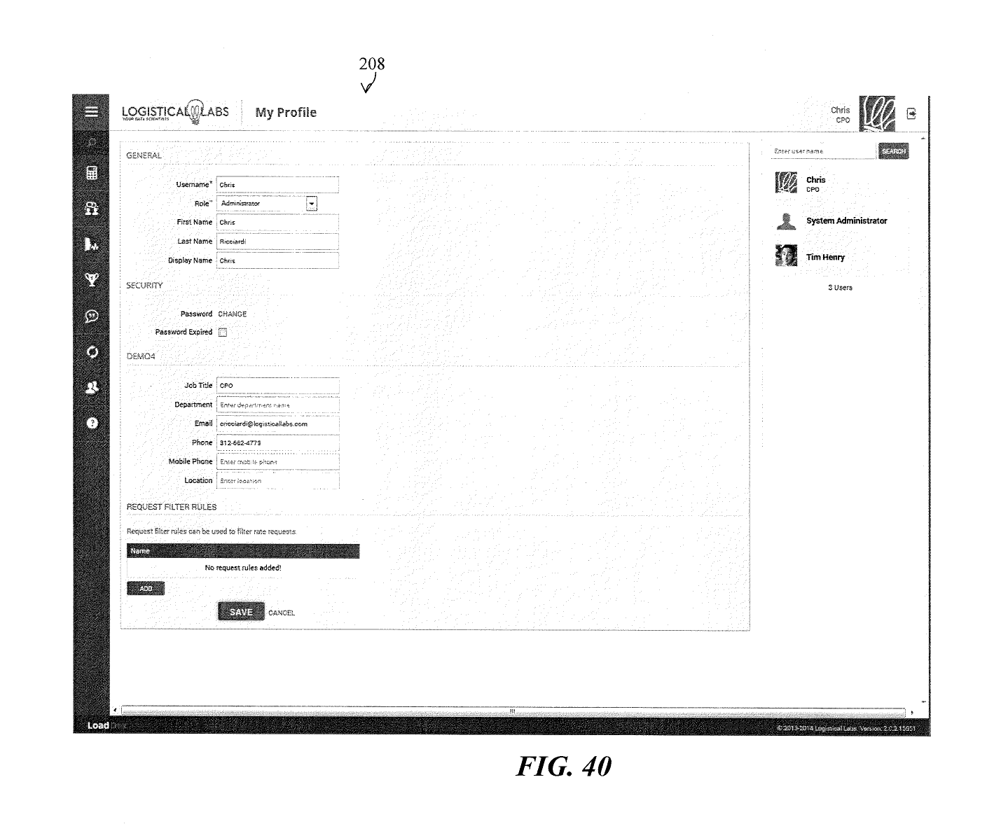

As noted above, a user and/or administrator may be able to edit a user profile through, for example, a page accessed through an “Edit” button 206 in the profile page (see FIG. 38). An exemplary profile edit page 208 is shown in FIG. 40. The user may be able to alter one or more aspects of the profile through the profile edit page 208.

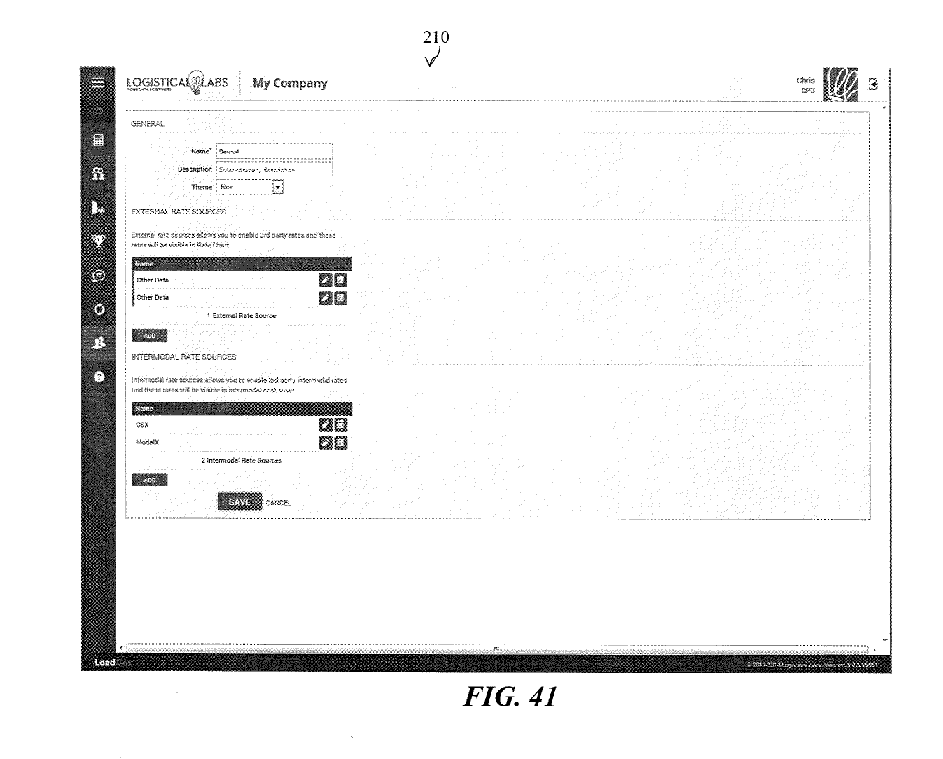

FIG. 41 depicts an exemplary company profile edit feature 210, through which permission for integrating external data sources may be given. As noted throughout this disclosure, external sources of data may be used to, e.g., provide a rate forecast, compare quotes with prevailing rates, etc. In an embodiment, multiple external sources of data may be available, and an administrator may be provided with the ability to enable and disable data sources individually. Accordingly, data sources may be added and removed as new sources become available and/or older sources prove more or less reliable or robust.

Referring again to FIG. 1, the central logistics system 16 may be configured, through hardware and/or software, to perform one or more of the functions described herein. For example, the central logistics system 16 may be configured to host the website described in conjunction with FIGS. 2-27. The central logistics system 16 may be further configured to receive data (e.g., messages, data through the data exchange feature, etc.) from users, send data to users (e.g., messages), perform necessary computations (e.g., for rate predictions, rate prediction stability indications, etc.), and to interact with other services (e.g., mapping services) and systems (e.g., the historical freight data repository and other data, which may be “cloud” storage) on behalf of the user. Thus, the central logistics system 16 may provide and enable a centralized system through which goods providers and freight providers can exchange freight cost bids, quotes, and negotiations, and award freight assignments, all with the use of past data to aid in determination of appropriate costs, bids, and quotes.

Although a number of embodiments have been described above with a certain degree of particularity, those skilled in the art could make numerous alterations to the disclosed embodiments without departing from the spirit or scope of this disclosure. For example, all joinder references (e.g., attached, coupled, connected, and the like) are to be construed broadly and may include intermediate members between a connection of elements and relative movement between elements. As such, joinder references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the disclosure as defined in the appended claims.

Any patent, publication, or other disclosure material, in whole or in part, that is said to be incorporated by reference herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A system for determining supply chain freight costs, the system comprising:
an electronic repository of historical freight data; and
a central logistics system, coupled with the repository of historical freight data so as to exchange data with the repository of historical freight data, the central logistics system configured to:
provide a website that is accessible to a plurality of goods provides and a plurality of freight providers;
receive, through the website, information about a desired shipment from one of the plurality of goods providers;
calculate, according to the historical freight data, an expected cost of the desired shipment;
receive, from at least one of the plurality of freight providers, a quote for the desired shipment; and
provide the quote for the one of the plurality of goods providers.

2. The system of claim 1, wherein the central logistics system comprises a processor.

3. The system of claim 1, wherein the central logistics system is configured to calculate the expected cost of the desired shipment according to a multiple regression analysis.

4. The system of claim 3, wherein the multiple regression analysis uses, as input, a plurality of weighted variables.

5. The system of claim 1, wherein the central logistics system is configured to calculate the expected cost of the desired shipment according to one or more of transit mode, time of year, time of day, weather, number of extra stops, commodity carried, pick up or delivery warehouse, customer, motor carrier (MC) number of carrier, and regions included in the freight route.

6. The system of claim 1, wherein the central logistics system is further configured to provide the expected cost of the desired shipment to the one of the plurality of goods providers.

7. The system of claim 1, wherein the central logistics system is further configured to:
calculate a stability of the expected cost of the desired shipment; and
provide the stability to the one of the plurality of goods providers.

8. The system of claim 1, wherein the central logistics system is further configured to make the desired shipment available for respective quotes from each of the plurality of freight providers.

9. The system of claim 1, wherein the central logistics system is further configured to:
receive, from one of the plurality of goods providers, a rate request respective of a specific one of the plurality of freight providers; and
provide the rate request to the specific freight provider.

10. The system of claim 1, wherein the central logistics system is further configured to provide a list of rates for the desired shipment, wherein the different rates includes rates for two or more shipping modes from the plurality of freight providers.

11. A method of facilitating shipment by one of a plurality of freight providers of goods from one of a plurality of goods providers, the method comprising:
providing a website that is accessible to a plurality of goods provides and a plurality of freight providers;
receiving, through the website, information about a desired shipment from one of the plurality of goods providers;
calculating, according to historical freight data, an expected cost of the desired shipment;
receiving, from at least one of the plurality of freight providers, a quote for the desired shipment; and
providing the quote for the one of the plurality of goods providers.

12. The method of claim 11, wherein the historical freight data comprises data respective of shipments arranged through the website and data respective of shipments not arranged through the website.

13. The method of claim 11, further comprising calculating the expected cost of the desired shipment according to a multiple regression analysis.

14. The method of claim 13, wherein the multiple regression analysis uses, as input, a plurality of weighted variables.

15. The method of claim 11, wherein calculating the expected cost of the desired shipment is performed according to one or more of transit mode, time of year, time of day, weather, number of extra stops, commodity carried, pick up or delivery warehouse, customer, motor carrier (MC) number of carrier, and regions included in the freight route.

16. The method of claim 11, further comprising providing the expected cost of the desired shipment to the one of the plurality of goods providers.

17. The method of claim 11, further comprising:
calculating a stability of the expected cost of the desired shipment; and
providing the stability to the one of the plurality of goods providers.

18. The method of claim 11, further comprising making the desired shipment available for respective quotes from each of the plurality of freight providers.

19. The method of claim 11, further comprising:
receiving, from one of the plurality of goods providers, a rate request respective of a specific one of the plurality of freight providers; and
providing the rate request to the specific freight provider.

20. The method of claim 11, further comprising providing a list of rates for the desired shipment, wherein the different rates includes rates for two or more shipping modes from the plurality of freight providers.
